(19) United States
(12) Patent Application Publication
(10) Pub. No.: US 2025/0254152 A1
(43) Pub. Date: Aug. 7, 2025

(54) ENHANCING MESSAGING INFRASTRUCTURE SECURITY

(71) Applicant: Dell Products L.P., Round Rock, TX (US)

(72) Inventors: Raveendra Babu Madala, Agiripalli (IN); Parmeshwr Prasad, Bangalore (IN); Santosh Gore, Bangalore (IN)

(73) Assignee: Dell Products L.P., Round Rock, TX (US)

(21) Appl. No.: 18/432,625

(22) Filed: Feb. 5, 2024

(51) Int. Cl. H04L 9/40

(52) U.S. Cl. CPC H04L 63/061; H04L 63/04; H04L 63/062

(57) ABSTRACT

Enhanced Information Handling System (IHS) messaging infrastructure security may include setting up, by a message producer, via a messaging resource rotation service, messaging resources in a message broker. The messaging resource rotation service may assign a routing key variable, and then a message consumer may subscribe, via the messaging resource rotation service, to the messaging resources pointed out by the routing key variable. The message producer may fetch a routing key variable derived value, to post a message, using this routing key derived variable value. Thereafter, the message broker may notify the subscribed message consumer about the posting of the message. Additionally, the messaging resource rotation service may rotate the routing key variable and/or the routing key variable derived value, may notify the message consumer of the new routing key in the message broker, and/or may store the routing key variable in a key vault, or with key management service.

### FIELD

This disclosure relates generally to Information Handling Systems (IHSs), and, more specifically, to enhancing IHS messaging infrastructure security.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

Embodiments of enhanced Information Handling System (IHS) messaging infrastructure security are described. In an illustrative, non-limiting example a messaging resource rotation service may set up, in response to a message producer application, set up, messaging resources in a message broker and assign a routing key variable. The messaging resource rotation service may then subscribe a message consumer application to the messaging resources, as pointed out by the routing key variable and provide a routing key variable derived value to the message producer application.

Thus, in accordance with embodiments for of the present enhanced IHS messaging infrastructure security, a method for providing the enhanced IHS messaging infrastructure security may include setting up, by a message producer application, via a messaging resource rotation service, messaging resources in a message broker, and assigning, by the messaging resource rotation service, a routing key variable. Thereafter, a message consumer application may subscribe, via the messaging resource rotation service, to the messaging resources, such as may be, as pointed out by the routing key variable. The message producer application may fetch a routing key variable derived value, to post a message, using this fetched routing key derived variable value. Thereafter, the message broker may notify the subscribed message consumer application about the posting of the message.

In accordance therewith, a system for providing enhanced IHS messaging infrastructure security may include a message producer application configured to be executed by an IHS to cause the IHS to set up, via a messaging resource rotation service, messaging resources in a message broker. This messaging resource rotation service may be configured to be executed by a same or an other IHS, may, upon execution causes the same or other IHS to assign a routing key variable. A message consumer application configured to be executed by the same, the other, or yet an other IHS may, upon execution cause the same, other, or yet other IHS to subscribe, via the messaging resource rotation service, to the messaging resources, such as, as pointed out by the routing key variable. The message producer application may also (then) cause the IHS to fetch a routing key variable derived value from the messaging resource rotation service and post a message, using the fetched routing key variable derived value. The messaging resource rotation service may also (then) cause the same or other IHS to notify, in the message broker, the message consumer application about the posting of the message.

In accordance with some embodiments, the messaging resource rotation service may rotate the routing key variable, and may notify, in the message broker, the message consumer application, of a new routing key variable resulting from rotation of the routing key variable. Additionally, or alternatively, in some embodiments, the messaging resource rotation service may also rotate the routing key variable derived value. Additionally, or alternatively, in some embodiments, the messaging resource rotation service may store the routing key variable in a key vault, or with key management service, in communication with the messaging resource rotation service.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram illustrating components of an example of an Information Handling System (IHS), according to some embodiments.

FIG. 2 is a diagram of existing IHS messaging infrastructure;

FIG. 3 is a diagram of enhanced IHS messaging infrastructure security, according to some embodiments; and

FIG. 4 is a flow diagram of a process for providing enhanced IHS messaging infrastructure security, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components.

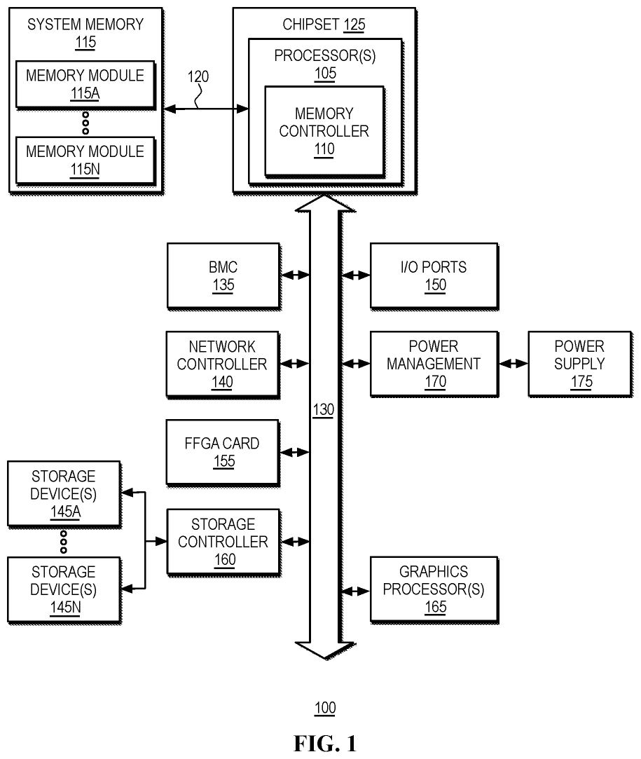

FIG. 1 is a block diagram of an example of internal components of IHS 100, which may employ and/or implement embodiments of the present enhancements for messaging infrastructure security, according to some embodiments. IHS 100 may utilize one or more processors 105. In some embodiments, processors 105 may include a main processor and a co-processor, each of which may include a plurality of processing cores that, in certain scenarios, may each be used to run an instance of a server process. In certain embodiments, one or all of processor(s) 105 may be graphics processing units (GPUs) in scenarios where IHS 100 has been configured to support functions such as multimedia services and graphics applications.

As illustrated, processor(s) 105 includes an integrated memory controller 110 that may be implemented directly within the circuitry of the processor 105, or the memory controller 110 may be a separate integrated circuit that is located on the same die as the processor 105. The memory controller 110 may be configured to manage the transfer of data to and from the system memory 115 of the IHS 105 via a high-speed memory interface 120. The system memory 115 is coupled to processor(s) 105 via a memory bus 120 that provides the processor(s) 105 with high-speed memory used in the execution of computer program instructions by the processor(s) 105. Accordingly, system memory 115 may include memory components, such as static RAM (SRAM), dynamic RAM (DRAM), NAND Flash memory, suitable for supporting high-speed memory operations by the processor(s) 105. In certain embodiments, system memory 115 may combine both persistent, non-volatile memory and volatile memory.

In certain embodiments, the system memory 115 may be comprised of multiple removable memory modules. The system memory 115 of the illustrated embodiment includes removable memory modules 115a-n. Each of the removable memory modules 115a-n may correspond to a printed circuit board memory socket that receives a removable memory module 115a-n, such as a DIMM (Dual In-line Memory Module), that can be coupled to the socket and then decoupled from the socket as needed, such as to upgrade memory capabilities or to replace faulty memory modules. Other embodiments of IHS memory 115 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 100 may utilize chipset 125 that may be implemented by integrated circuits that are coupled to processor(s) 105. In this embodiment, processor(s) 105 is depicted as a component of chipset 125. In other embodiments, all of chipset 125, or portions of chipset 125 may be implemented directly within the integrated circuitry of processor(s) 105. The chipset may provide the processor(s) 105 with access to a variety of resources accessible via one or more buses 130. Various embodiments may utilize any number of buses to provide the illustrated pathways served by bus 130. In certain embodiments, bus 130 may include a PCIe switch fabric that is accessed via a PCIe root complex.

As illustrated, IHS 100 includes BMC 135 to provide capabilities for remote monitoring and management of various aspects of IHS 100. In support of these operations, BMC 135 may utilize both in-band, sideband and/or out of band communications with certain managed components of IHS 100, such as, for example, processor(s) 105, system memory 115, chipset 125, network controller 140, storage device(s) 145, etc. BMC 135 may be installed on the motherboard of IHS 100 or may be coupled to IHS 100 via an expansion slot provided by the motherboard. As a non-limiting example of a BMC, the integrated Dell Remote Access Controller (iDRAC) from Dell® is embedded within Dell PowerEdge™ servers and provides functionality that helps information technology (IT) administrators deploy, update, monitor, and maintain servers remotely. BMC 135 may include non-volatile memory having program instructions stored thereon that are usable by CPU(s) 105 to enable remote management of IHS 100. For example, BMC 135 may enable a user to discover, configure, and manage BMC 135, setup configuration options, resolve and administer hardware or software problems, etc. Additionally, or alternatively, BMC 135 may include one or more firmware volumes, each volume having one or more firmware files used by the BIOS' firmware interface to initialize and test components of IHS 100.

IHS 100 may also include the one or more I/O ports 150, such as USB ports, PCIe ports, TPM (Trusted Platform Module) connection ports, HDMI ports, audio ports, docking ports, network ports, Fibre Channel ports and other storage device ports. Such I/O ports 150 may be externally accessible or may be internal ports that are accessed by opening the enclosure of the IHS 100. Through couplings made to these I/O ports 150, users may couple the IHS 100 directly to other IHSs, storage resources, external networks and a vast variety of peripheral components.

As illustrated, IHS 100 may include one or more FPGA (Field-Programmable Gate Array) cards 155. Each of the FPGA card 155 supported by IHS 100 may include various processing and memory resources, in addition to an FPGA logic unit that may include circuits that can be reconfigured after deployment of IHS 100 through programming functions supported by the FPGA card 155. Through such reprogramming of such logic units, each individual FGPA card 155 may be optimized to perform specific processing tasks, such as specific signal processing, security, data mining, and artificial intelligence functions, and/or to support specific hardware coupled to IHS 100. In some embodiments, a single FPGA card 155 may include multiple FPGA logic units, each of which may be separately programmed to implement different computing operations, such as in computing different operations that are being offloaded from processor 105.

IHS 100 may include one or more storage controllers 160 that may be utilized to access storage devices 145a-n that are accessible via the chassis in which IHS 100 is installed. Storage controller 160 may provide support for RAID (Redundant Array of Independent Disks) configurations of logical and physical storage devices 145a-n. In some embodiments, storage controller 160 may be an HBA (Host Bus Adapter) that provides more limited capabilities in accessing physical storage devices 145a-n. In some embodiments, storage devices 145a-n may be replaceable, hot-swappable storage devices that are installed within bays provided by the chassis in which IHS 100 is installed. In embodiments where storage devices 145a-n are hot-swappable devices that are received by bays of chassis, the storage devices 145a-n may be coupled to IHS 100 via couplings between the bays of the chassis and a midplane of IHS 100. In some embodiments, storage devices 145a-n may also be accessed by other IHSs that are also installed within the same chassis as IHS 100. Storage devices 145a-n may include SAS (Serial Attached SCSI) magnetic disk drives, SATA (Serial Advanced Technology Attachment) magnetic disk drives, solid-state drives (SSDs) and other types of storage devices in various combinations.

Processor(s) 105 may also be coupled to a network controller 140 via bus 130, such as provided by a Network Interface Controller (NIC) that allows the IHS 100 to communicate via an external network, such as the Internet or a LAN. In some embodiments, network controller 140 may be a replaceable expansion card or adapter that is coupled to a motherboard connector of IHS 100. In some embodiments, network controller 140 may be an integrated component of IHS 100.

A variety of additional components may be coupled to processor(s) 105 via bus 130. For instance, processor(s) 105 may also be coupled to a power management unit 165 that may interface with a power supply of IHS 100. In certain embodiments, a graphics processor 170 may be comprised within one or more video or graphics cards, or an embedded controller, installed as components of the IHS 100.

In certain embodiments, IHS 100 may operate using a BIOS (Basic Input/Output System) that may be stored in a non-volatile memory accessible by the processor(s) 105. The BIOS may provide an abstraction layer by which the operating system of the IHS 100 interfaces with the hardware components of the IHS. Upon powering or restarting IHS 100, processor(s) 105 may utilize BIOS instructions to initialize and test hardware components coupled to the IHS, including both components permanently installed as components of the motherboard of IHS 100 and removable components installed within various expansion slots supported by the IHS 100. The BIOS instructions may also load an operating system for use by the IHS 100. In certain embodiments, IHS 100 may utilize Unified Extensible Firmware Interface (UEFI) in addition to or instead of a BIOS. In certain embodiments, the functions provided by a BIOS may be implemented, in full or in part, by the remote access controller 135. In some embodiments, BIOS may be configured to identify hardware components that are detected as being currently installed in IHS 100. In such instances, the BIOS may support queries that provide the described unique identifiers that have been associated with each of these detected hardware components by their respective manufacturers. In providing an abstraction layer by which hardware of IHS 100 is accessed by an operating system, BIOS may identify the I/O ports 150 that are recognized and available for use.

In some embodiments, IHS 100 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of IHS, such as the BIOS and boot loader of IHS 100. These calculated hash values may then be compared against reference hash values that were previously stored in a secure non-volatile memory of the IHS, such as during factory provisioning of IHS 100. In this manner, a TPM may establish a root of trust that includes core components of IHS 100 that are validated as operating using instructions that originate from a trusted source.

In various embodiments, an IHS 100 does not include each of the components shown in FIG. 1. In various embodiments, an IHS 100 may include various additional components in addition to those that are shown in FIG. 1. Furthermore, some components that are represented as separate components in FIG. 1 may in certain embodiments instead be integrated with other components. For example, in certain embodiments, all or a portion of the functionality provided by the illustrated components may instead be provided by components integrated into the one or more processor(s) 105 as a systems-on-a-chip.

IHS 100 is generally illustrated as a server (e.g., blade server or rack server). However, as noted embodiments of the present enhanced messaging infrastructure security may be employed by various other types of IHSs as well, such as a personal computer (e.g., desktop or laptop), tablet computer, mobile device (e.g., personal digital assistant (PDA) or smart phone), a network storage device, or any other suitable device. For example, as a person of ordinary skill will recognize, the embodiments described herein may be used in various electronic devices, such as network router devices, televisions, custom telecommunications equipment for special purpose use, etc. That is, certain techniques described herein are in no way limited to use with the IHS of FIG. 1.

Complex software systems creation and maintenance may require that several teams to work together. Each team might be responsible for a set of functionalities. Teams are adopting a microservices architecture to enable independent development, deployment, and maintenance of the services “owned” by them. The microservices provided and/or owned by several teams work together to provide the required functionality to the end user. To achieve an outcome for the end user, several services must work together. Messaging infrastructure is used for streaming-based data exchange between microservices. Typically, resources (queues, exchanges, and virtual hosts) are tightly coupled among the services. Usually, they are fixed and are not subsequently changed.

A message broker (also known as an integration broker or interface engine) is an intermediary computer program module that translates a message from a messaging protocol of the sender to a messaging protocol of the receiver. Message brokers are elements in telecommunication or computer networks where software applications communicate by exchanging formally-defined messages. A message broker is an architectural pattern for message validation, transformation, and routing. It mediates communication among applications, minimizing mutual awareness that applications have of each other in order to be able to exchange messages, effectively implementing decoupling.

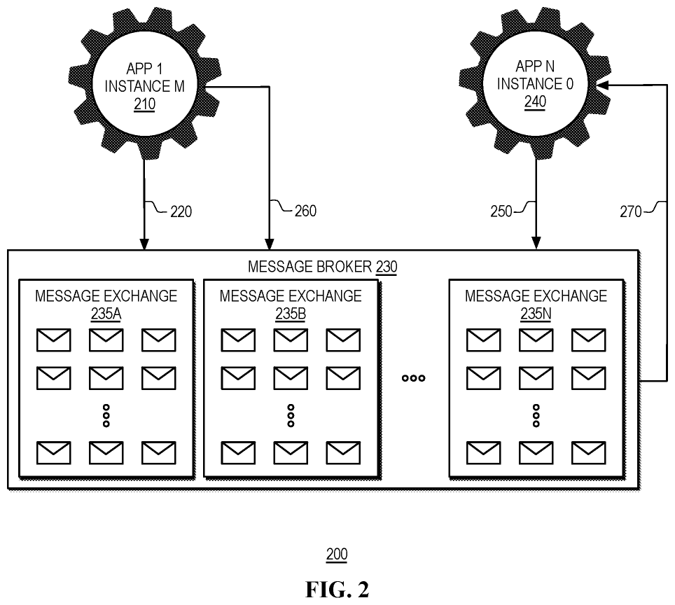

FIG. 2 is a diagram of existing IHS messaging infrastructure 200. Therein, message producer application 210 sets up (220) messaging resources in message broker 230, and a routing key is assigned. A routing key is generated by the producer application and is a part of messages along with the message payload. Exchanges 235a-n are message routing agents, which, by way of example, are defined by a virtual host within message broker 230. Exchanges 235a-n are responsible for routing the messages to different queues with the help of header attributes, bindings, and routing keys. Thus, message broker exchanges 235a-n look at the routing key when determining how a message has to be routed. That is, the routing key is a message attribute that exchanges 235a-n use to determine how to route a message to queues, within exchanges 235a-n. A binding is a “link” set up to bind a queue to an exchange. Consumer application 240 subscribes (250) to the messaging resource. Producer application 210 posts (260) messages using the routing key. Messages are not published directly to a queue, rather producer application 210 sends messages to exchange 235a-n. Message broker 230 notifies (270) subscribed consumer application 220 about the posted message.

However, once any resource (queues, binding, exchanges, virtual hosts, etc.) is fixed (e.g. following 220), if relationships and binding are exposed, anyone can snoop on the messages. These messages can potentially contain confidential and sensitive data that can be exploited. The encryption used is typically Base64, so anyone can easily decipher the data. For at least these reasons, existing IHS messaging infrastructure security is vulnerable and can possibly be exploited.

Embodiments disclosed herein relate generally to IHSs, specifically enhancing IHS messaging infrastructure security. Embodiments of the present enhancements for IHS messaging infrastructure security intensively rotate relationships among the resources in messaging infrastructure. The end resource is derived from the top, or parent, node. In accordance with embodiments of the present enhancements for IHS messaging infrastructure security, this information is shared between producer applications and consumer applications through environmental variables stored in a vault or key management service. A separate messaging resource rotation service is created in accordance with embodiments of the present enhancements for IHS messaging infrastructure security to keep producer applications and consumer applications synchronized with (the) new resource(s). The key used to rotate will also be stored in the vault, in various embodiments of the present enhancements for IHS messaging infrastructure security.

Thus, in accordance with some embodiments, as detailed below, enhanced IHS messaging infrastructure security may include setting up, by a message producer, via a messaging resource rotation service, messaging resources in a message broker. The messaging resource rotation service may assign a routing key variable, and then a message consumer may subscribe, via the messaging resource rotation service, to the messaging resources pointed out by the routing key variable. The message producer may fetch a routing key variable derived value, to post a message, using this routing key derived variable value. Thereafter, the message broker may notify the subscribed message consumer about the posting of the message. Additionally, the messaging resource rotation service may rotate the routing key variable and/or the routing key variable derived value, may notify the message consumer of the new routing key in the message broker, and/or may store the routing key variable in a key vault, or with key management service.

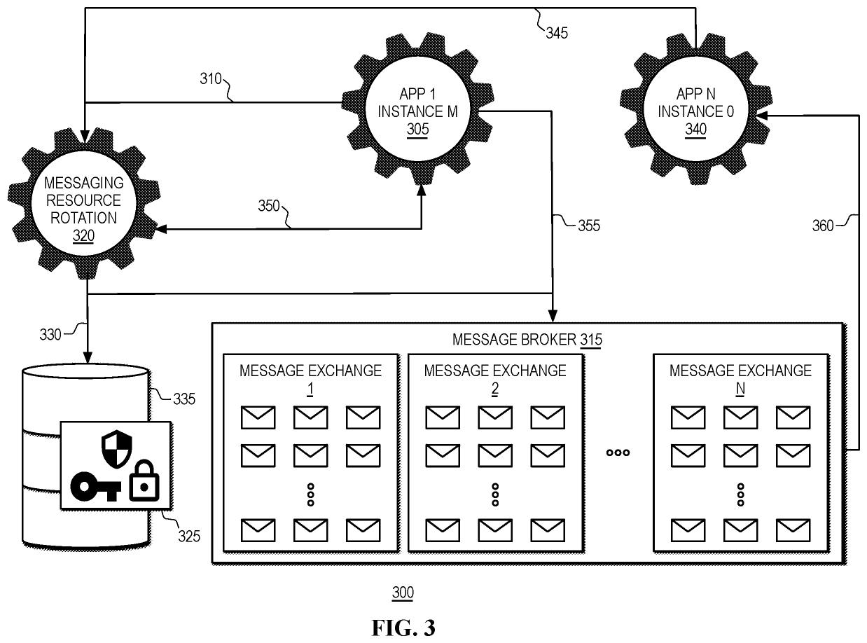

FIG. 3 is a diagram of enhanced IHS messaging infrastructure security 300, according to some embodiments of the present enhancements for IHS messaging infrastructure security. Therein, producer application 305 sets up (310) messaging resources in message broker 315, via messaging resource rotation service 320. Routing key variable 325 is assigned (by the messaging resource rotation service) and secured 330 in vault or key management service 335. Consumer application 340 subscribes (345), via messaging resource rotation service 320, to messaging resources pointed out by routing key variable 325. Producer application 305 fetches (350) a routing key variable 325 value, and the producer application posts (355) messages using the fetched value. Message broker 315 notifies (360) subscribed consumer application 340 about the posted message. In accordance with embodiments of the present enhancements for IHS messaging infrastructure security, messaging resource rotation service 320 performs rotation of routing key variable 325 and adjusts subscriber applications (e.g., 340 and 305) accordingly, such as, in (via) message broker 315.

Accordingly, messaging resource rotation service 320, relatively intensively, rotates the relationships among the resources in the messaging infrastructure, such that end resources are derived from the top, or parent, node. Through messaging resource rotation service 320, embodiments of the present enhancements for IHS messaging infrastructure security share the routing key variable 325 between producer applications (e.g., 305) and consumer applications (e.g., 340) and stores 330 routing key variable 325 vault or key management service 335. Thereby, a separate messaging resource rotation service 320, created in accordance with embodiments for enhancing IHS messaging infrastructure security to thusly keep producer applications (e.g., 305) and consumer applications (e.g., 340) producer applications and consumer applications in sync with this new resource (i.e., routing key variable 325).

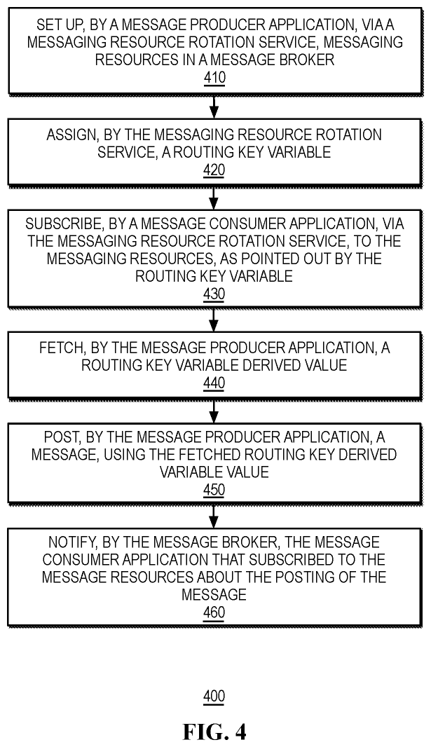

FIG. 4 is a flow diagram of process 400 for enhancing IHS messaging infrastructure security, according to some embodiments. Therein, at 410, a producer application (305) sets up messaging resources in the message broker (315) via the messaging resource rotation service (320). A routing key variable (325) is assigned at 420, such as by the messaging resource rotation service, and may, in accordance with various embodiments, be secured 330 in a vault (335) or with a key management service. At 430, the consumer application (340) subscribes, via the messaging resource rotation service, to messaging resources pointed out by the routing key variable. At 440, the producer application fetches a routing key variable derived value, and the producer application posts messages, at 450, using this fetched value. At 460, the message broker notifies the subscribed consumer application(s) about the message posted at 450. In accordance with embodiments of the present enhancements for IHS messaging infrastructure security, the messaging resource rotation service performs rotation of the routing key variable and adjusts subscriber applications accordingly in the message broker.

In accordance with the foregoing, embodiments of the present enhancements for IHS messaging infrastructure security provide new and dynamic methods to bind messaging resources between producer applications and consumer applications, and provides secure methods to synchronize the messaging resources between producer applications and consumer applications, which enhances the messaging infrastructure's security so that unwarranted snooping can be avoided.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

To implement various operations described herein, computer program code (i.e., instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. A method for providing enhanced Information Handling System (IHS) messaging infrastructure security comprising:
setting up, by a message producer application, via a messaging resource rotation service, messaging resources in a message broker;
assigning, by the messaging resource rotation service, a routing key variable;
subscribing, by a message consumer application, via the messaging resource rotation service, to the messaging resources;
fetching, by the message producer application, a routing key variable derived value;
posting, by the message producer application, a message, using the fetched routing key derived variable value; and
notifying, the message consumer application that subscribed to the message resources, by the message broker, about the posting of the message.

2. The method of claim 1, further comprising rotating the routing key variable, by the messaging resource rotation service.

3. The method of claim 2, further comprising notifying, in the message broker, by the messaging resource rotation service, the message consumer application that subscribed to the message resources, of a new routing key variable resulting from rotation of the routing key variable.

4. The method of claim 1, further comprising rotating the routing key variable derived value, by the messaging resource rotation service rotates.

5. The method of claim 1, further comprising, storing, by the messaging resource rotation service, the routing key variable in a key vault in communication with the messaging resource rotation service.

6. The method of claim 1, further comprising storing, by the messaging resource rotation service, the routing key variable with a key management service in communication with the messaging resource rotation service.

7. The method of claim 1, wherein, in subscribing, by a message consumer application, via the messaging resource rotation service, to the messaging resources, the messaging resources are pointed out by the routing key variable.

8. A memory storage device having messaging resource rotation service program instructions stored thereon that, upon execution by an Information Handling System (IHS), cause the IHS to provide enhanced messaging infrastructure security by:
set up, in response to a message producer application, messaging resources in a message broker;
assign a routing key variable;
subscribe a message consumer application to the messaging resources, as pointed out by the routing key variable; and
provide a routing key variable derived value to the message producer application.

9. The memory storage device of claim 8, wherein, the messaging resource rotation service program instructions rotates the routing key variable.

10. The memory storage device of claim 9, wherein, the messaging resource rotation service instructions notifies, in the message broker, the message consumer application, of a new routing key variable resulting from rotation of the routing key variable.

11. The memory storage device of claim 8, wherein, the messaging resource rotation service instructions rotates the routing key variable derived value.

12. The memory storage device of claim 8, wherein, the messaging resource rotation service instructions store the routing key variable in a key vault in communication with the messaging resource rotation service.

13. The memory storage device of claim 8, wherein, the messaging resource rotation service instructions store the routing key variable with key management service in communication with the messaging resource rotation service.

14. A system for providing enhanced Information Handling System (IHS) messaging infrastructure security comprising:
a message producer application configured to be executed by an IHS comprising a processor and a memory coupled to the processor, the memory comprising the message producer application, which upon execution by the processor causes the IHS to set up, via a messaging resource rotation service, messaging resources in a message broker;
the messaging resource rotation service configured to be executed by a same or an other IHS, which upon execution by the same or other IHS, causes the same or other IHS to assign a routing key variable;
a message consumer application configured to be executed by the same, the other, or yet an other IHS, which upon execution by the same or other IHS causes the same, other, or yet other IHS to, subscribe, via the messaging resource rotation service, to the messaging resources;
the message producer application further causes the IHS to fetch a routing key variable derived value from the messaging resource rotation service and post a message, using the fetched routing key variable derived value; and
the messaging resource rotation service further causes the same or other IHS to notify the message consumer application that subscribed to the message resources, by the message broker, about the posting of the message.

15. The system of claim 14, wherein, the messaging resource rotation service causes the same or other IHS to rotate the routing key variable.

16. The system of claim 15, wherein, the messaging resource rotation service causes the same or other IHS to notify, in the message broker, the message consumer application that subscribed to the message resources, of a new routing key variable resulting from rotation of the routing key variable.

17. The system of claim 14, wherein, the messaging resource rotation service causes the same or other IHS to rotate the routing key variable derived value.

18. The system of claim 14, wherein, the messaging resource rotation service causes the same or other IHS to store the routing key variable in a key vault in communication with the messaging resource rotation service.

19. The system of claim 14, wherein, t the messaging resource rotation service causes the same or other IHS to store the routing key variable with a key management service in communication with the messaging resource rotation service.

20. The system of claim 14, wherein, in subscribing, by a message consumer application, via the messaging resource rotation service, to the messaging resources, the messaging resources are pointed out by the routing key variable.
